(19) United States
(12) Patent Application Publication
(10) Pub. No.: US 2015/0052013 A1
(43) Pub. Date: Feb. 19, 2015

(54) CUSTOMER SERVICE APPARATUS FOR PROVIDING SERVICES TO CUSTOMERS WHEN ASSESSING AND/OR PURCHASING ITEMS

(71) Applicant: MyPose Oy, Oulu (FI)

(72) Inventors: Lassi ANTTONEN, Oulu (FI); Ari RAUTIAINEN, Oulu (FI); Jonna MUURINEN, Oulu (FI); Antti KOSUNEN, Helsinki (FI); Juho RISKU, Oulu (FI); Topi JÄRVINEN, Kerava (FI)

(73) Assignee: MyPose Oy, Oulu (FI)

(21) Appl. No.: 13/966,952

(22) Filed: Aug. 14, 2013

(51) Int. Cl. G06Q 30/06

(52) U.S. Cl. CPC G06Q 30/0613
USPC 705/26.41

(57) ABSTRACT

A customer service apparatus for providing a service to a customer when assessing and/or purchasing one or more items is provided. The customer service apparatus includes an image capture arrangement for capturing one or more images of the customer, and generating corresponding image data, and a data processing arrangement for processing the image data for generating corresponding output data. The customer service apparatus also includes an image presentation arrangement for receiving the output data from the data processing arrangement for presenting to the customer the images captured by the image capture arrangement. Furthermore, the customer service apparatus includes a communication arrangement for communicating information derived from the images of the customer together with customer identification metadata to one or more parties for assessing the information derived from the images in association with the customer identification metadata, and for receiving feedback from the parties to be communicated to the customer.

### TECHNICAL FIELD

The present disclosure generally relates to systems for accessing and purchasing items in retailing environments, and more specifically, to customer service apparatus for providing a service to a customer when assessing and/or purchasing one or more items. Moreover, the present disclosure relates to methods of operating customer service apparatus for providing a service to a customer when assessing and/or purchasing one or more items. Furthermore, the present disclosure also relates to software products recorded on non-transitory machine-readable data storage media, wherein the software products are executable upon computing hardware to implement the aforesaid methods.

### BACKGROUND

Most retail stores provide tools, such as mirrors, to help customers to find wearable items of interest and appropriateness to the customers. For example, a customer may try on a wearable item and look into a mirror provided at a retail store to check how the wearable item looks on him/her. However, when trying a large number of wearable items, customers often find it difficult to compare what looked best on them.

Moreover, when making purchase decisions, customers often seek for feedback from their friends and/or family, who may not always be present in near spatial proximity to the customers. Presently, the customers may use cameras on their mobile phones to take their images and send the images to their friends and/or family for feedback. However, such a feedback mechanism is not easy to use, and therefore, is not scalable.

Therefore, there exists a need for a customer service apparatus for providing a service to a customer when assessing and/or purchasing one or more items.

### BRIEF SUMMARY

The present disclosure seeks to provide a customer service apparatus for providing a service to a customer when assessing and/or purchasing one or more items.

The present disclosure also seeks to provide a method of operating the customer service apparatus thereof.

In one aspect, embodiments of the present disclosure provide a customer service apparatus for providing a service to a customer when assessing and/or purchasing one or more items. The customer service apparatus includes an image capture arrangement that is operable to capture one or more images of the customer, and generate corresponding image data. In addition, the customer service apparatus includes a data processing arrangement that is operable to process the image data to generate corresponding output data. The customer service apparatus also includes an image presentation arrangement that is operable to receive the output data from the data processing arrangement, and present to the customer the images captured by the image capture arrangement.

Moreover, the image capture arrangement may include one or more digital cameras for capturing the images of the customer. The data processing arrangement may be operable to identify one or more customer gestures in the images captured by the image capture arrangement, and use the customer gestures for controlling operation of the customer service apparatus.

Moreover, the image presentation arrangement may include one or more pixel displays for presenting the images to the customer. The pixel displays may be implemented as one or more touch screens that may be operable to receive touch commands from the customer. The touch commands received from the customer may then be communicated to the data processing arrangement for controlling operation of the customer service apparatus. Alternatively, the pixel displays may be implemented as one or more projection screens.

Additionally, the data processing arrangement may be operable to receive input from the customer for purchasing one or more items presented to the customer by the customer service apparatus via its image presentation arrangement.

Moreover, the data processing arrangement may be operable to present targeted advertisement to the customer via the image presentation arrangement. The targeted advertisement may be based, at least in part, upon customer identification metadata, and/or identification of one or more items worn or carried by the customer when the images of the customer were captured.

Accordingly, the data processing arrangement may be operable to identify the items worn or carried by the customer when the images of the customer were captured. For this purpose, the data processing arrangement may be operable to perform one or more analyses on the images of the customer.

Additionally, the customer service apparatus may include a sensing arrangement for sensing one or more identification tags of the items worn or carried by the customer for determining their identity.

Furthermore, the customer service apparatus also includes a communication arrangement that is operable to communicate information derived from the images of the customer together with the customer identification metadata to one or more parties. The information derived from the images may, for example, pertain to the items worn or carried by the customer when the images of the customer were captured.

Upon receipt, the parties may assess the information derived from the images in association with the customer identification metadata to provide feedback to be communicated to the customer. Accordingly, the communication arrangement may be operable to receive the feedback from the parties.

Subsequently, the data processing arrangement may be operable to supply to the customer the feedback received from the parties. Beneficially, the feedback may be supplied to the customer in real time.

Beneficially, the feedback may be supplied in a form of a peer-review of the customer's choice of the items. Such feedback may help the customer to take a decision on whether or not to purchase one or more of the items.

Moreover, the customer service apparatus may be operable to select one or more recommended and/or related items, based upon the items worn or carried by the customer when the images of the customer were captured. The customer service apparatus may then be operable to present these recommended and/or related items to the customer via the image presentation arrangement.

Beneficially, the recommended and/or related items may be presented to the customer in a manner overlaid onto a presented image of the customer as captured by the image capture arrangement.

Moreover, the customer service apparatus may be operable to provide the customer substantially simultaneously with a plurality of views of the customer in real time. Beneficially, the customer service apparatus may be configurable to function as a mirror for providing the customer with a real-time image of the customer at one or more viewing angles.

Additionally, the image capture arrangement may be operable to capture one or more three-dimensional images of the customer, wherefrom the image presentation arrangement may be operable to present at least one of the three-dimensional images to the customer.

Additionally, the data processing arrangement may be operable to provide one or more portrait images of the customer as captured by the image capture arrangement.

Furthermore, embodiments of the present disclosure are suitable for retailing environments, such as retail stores, exhibitions, outdoor marketing events and amusement parks, but not limited thereto. Beneficially, the customer service apparatus may be implemented for use in a retail store. The customer service apparatus may enable a store owner to understand trends and patterns in behavior of customers. For this purpose, the data processing arrangement may be operable to store information pertaining to the customers for use in at least one of: marketing and sales analyses, marketing campaigns, marketing promotions, and/or aggregate sales and marketing data.

In another aspect, embodiments of the present disclosure provide a method of operating the customer service apparatus for providing the service to the customer when assessing and/or purchasing the items.

In yet another aspect, embodiments of the present disclosure provide a software product recorded on non-transitory machine-readable data storage media, wherein the software product is executable upon computing hardware for implementing the aforementioned method.

Embodiments of the present disclosure substantially eliminate the aforementioned problems in the prior art, and enable customers to take decisions on whether or not to purchase particular items, by allowing the customers to receive feedback from their friends, family and/or peers, who may not be physically present with them, and thereby facilitate virtual social experiences for the customers; facilitate personalized shopping experiences for the customers; enable store owners of retail stores to understand trends and patterns in behavior of their customers; and allow the store owners and/or advertisers to provide targeted advertising to the customers.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example network environment that is suitable for practicing various implementations of the present disclosure;

FIG. 2 is a schematic illustration of a customer service apparatus for providing a service to a customer when assessing and/or purchasing one or more items, in accordance with an embodiment of the present disclosure;

FIG. 3 is an illustration of an example image of the customer as shared by the customer service apparatus for feedback, in accordance with an embodiment of the present disclosure; and

FIG. 4 is an illustration of steps of a method of operating the customer service apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which it can be implemented. Although the best mode of carrying out the present disclosure has been disclosed, those in the art would recognize that other embodiments for carrying out or practicing the present disclosure are also possible.

Embodiments of the present disclosure provide a customer service apparatus for providing a service to a customer when assessing and/or purchasing one or more items. The customer service apparatus includes an image capture arrangement that is operable to capture one or more images of the customer, and generate corresponding image data. In addition, the customer service apparatus includes a data processing arrangement that is operable to process the image data to generate corresponding output data. The customer service apparatus also includes an image presentation arrangement that is operable to receive the output data from the data processing arrangement, and present to the customer the images captured by the image capture arrangement.

Moreover, the image capture arrangement may include one or more digital cameras for capturing the images of the customer. The data processing arrangement may be operable to identify one or more customer gestures in the images captured by the image capture arrangement, and use the customer gestures for controlling operation of the customer service apparatus.

Moreover, the image presentation arrangement may include one or more pixel displays for presenting the images to the customer. The pixel displays may be implemented as one or more touch screens that may be operable to receive touch commands from the customer. The touch commands received from the customer may then be communicated to the data processing arrangement for controlling operation of the customer service apparatus. Alternatively, the pixel displays may be implemented as one or more projection screens.

Additionally, the data processing arrangement may be operable to receive input from the customer for purchasing one or more items presented to the customer by the customer service apparatus via its image presentation arrangement.

Moreover, the data processing arrangement may be operable to present targeted advertisement to the customer via the image presentation arrangement. The targeted advertisement may be based, at least in part, upon customer identification metadata, and/or identification of one or more items worn or carried by the customer when the images of the customer were captured. The items may, for example, include clothing items and/or accessory items, such as apparels, spectacles, handbags, rucksacks, footwear and jewelry, and sports items, such as sport bicycles, racquets, golf clubs, balls and other sports equipment.

Accordingly, the data processing arrangement may be operable to identify the items worn or carried by the customer when the images of the customer were captured. For this purpose, the data processing arrangement may be operable to perform one or more analyses on the images of the customer.

Additionally, the customer service apparatus may include a sensing arrangement for sensing one or more identification tags of the items worn or carried by the customer for determining their identity.

Furthermore, the customer service apparatus also includes a communication arrangement that is operable to communicate information derived from the images of the customer together with the customer identification metadata to one or more parties. The information derived from the images may, for example, pertain to the items worn or carried by the customer when the images of the customer were captured.

Upon receipt, the parties may assess the information derived from the images in association with the customer identification metadata to provide feedback to be communicated to the customer. Accordingly, the communication arrangement may be operable to receive the feedback from the parties.

Subsequently, the data processing arrangement may be operable to supply to the customer the feedback received from the parties. Beneficially, the feedback may be supplied to the customer in real time, for example, via the image presentation arrangement.

Beneficially, the feedback may be supplied in a form of a peer-review of the customer's choice of the items. Such feedback may help the customer to take a decision on whether or not to purchase one or more of the items.

Moreover, the customer service apparatus may be operable to select one or more recommended and/or related items, based upon the items worn or carried by the customer when the images of the customer were captured. The customer service apparatus may then be operable to present these recommended and/or related items to the customer via the image presentation arrangement.

Beneficially, the recommended and/or related items may be presented to the customer in a manner overlaid onto a presented image of the customer as captured by the image capture arrangement.

Moreover, the customer service apparatus may be operable to provide the customer substantially simultaneously with a plurality of views of the customer in real time. Beneficially, the customer service apparatus may be configurable to function as a mirror for providing the customer with a real-time image of the customer at one or more viewing angles.

Additionally, the image capture arrangement may be operable to capture one or more three-dimensional images of the customer, wherefrom the image presentation arrangement may be operable to present at least one of the three-dimensional images to the customer.

Additionally, the data processing arrangement may be operable to provide one or more portrait images of the customer as captured by the image capture arrangement.

Furthermore, embodiments of the present disclosure are suitable for retailing environments, such as retail stores, exhibitions, outdoor marketing events and amusement parks, but not limited thereto. Beneficially, the customer service apparatus may be implemented for use in a retail store. The customer service apparatus may enable a store owner to understand trends and patterns in behavior of customers. For this purpose, the data processing arrangement may be operable to store information pertaining to the customers for use in at least one of: marketing and sales analyses, marketing campaigns, marketing promotions, and/or aggregate sales and marketing data.

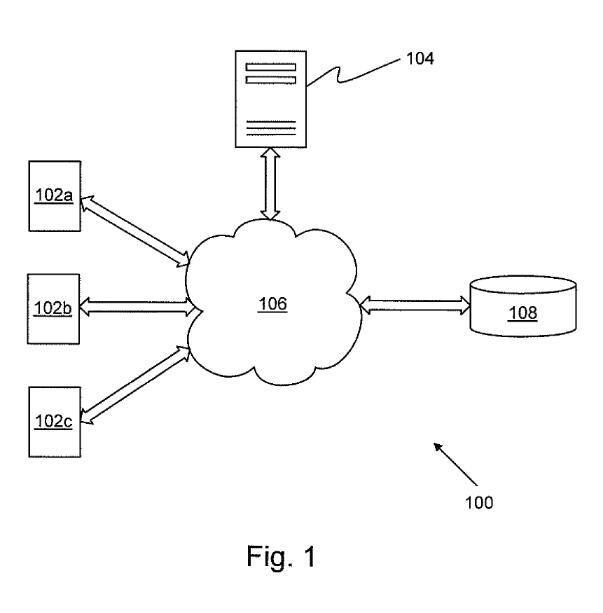

Referring now to the drawings, particularly by their reference numbers, FIG. 1 is a schematic illustration of an example network environment 100 that is suitable for practicing various implementations of the present disclosure. The network environment 100 includes one or more customer service apparatus, depicted as a customer service apparatus 102a, a customer service apparatus 102b and a customer service apparatus 102c in FIG. 1 (hereinafter collectively referred to as customer service apparatus 102). The network environment 100 also includes one or more servers, one or more data communication networks, and one or more databases, depicted as a server 104, a data communication network 106, and a database 108 in FIG. 1, respectively.

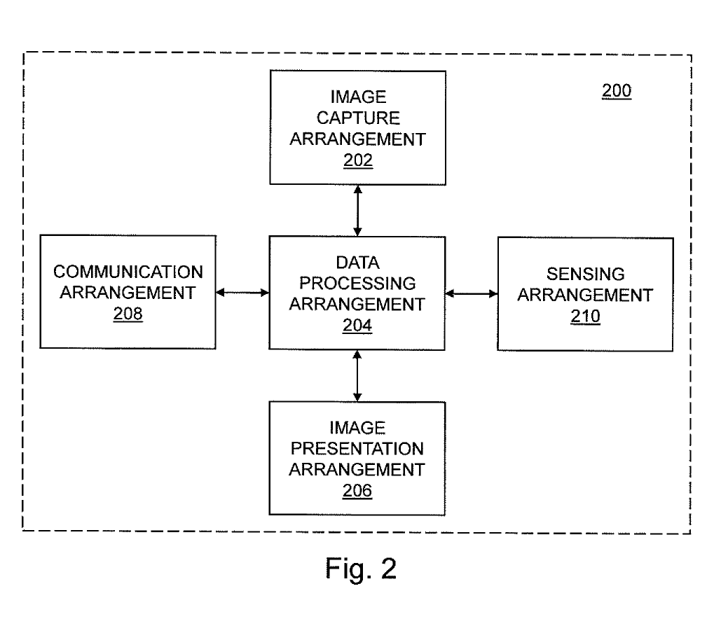

The customer service apparatus 102 are operable to execute one or more software products recorded on non-transitory machine-readable data storage media. The customer service apparatus 102 are operable to provide various services to customers when assessing and/or purchasing various items in these retail stores. Details of the customer service apparatus 102 have been provided in conjunction with FIG. 2.

Let us consider an example scenario in which the customer service apparatus 102 are spatially implemented at various retail stores and/or at various spatial locations within a particular retail store. In some cases, the retail stores could be distributed at various geographical locations. In other cases, the retail stores could be located in proximities of each other, for example, within one retailing premises.

Optionally, the server 104 and the database 108 may be implemented via cloud computing services.

Moreover, the data communication network 106 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), and Wireless MANs (WMANs).

The data communication network 106 couples the customer service apparatus 102 to the server 104 and the database 108. For example, the customer service apparatus 102 may be operable to store information pertaining to the customers in the database 108 (hereinafter referred to as “customer information”). The customer information may then be accessed from the database 108, as and when required.

Additionally, the server 104 may be operable to use the customer information in at least one of: marketing and sales analyses, marketing campaigns, marketing promotions, and/or aggregate sales and marketing data.

For example, the server 104 may be operable to analyze aggregate data pertaining to actions performed by the customers, feedbacks provided by the customers and/or their friends, and overall purchase process of the customers. Based upon the analyses, the server 104 may be operable to keep a track of trends and patterns in behavior of the customers.

This may enable store owners of the retail stores to understand not only actions taken by their customers that resulted in purchases in their retail stores, but also actions taken by their customers that did not result in purchases. This may also help the store owners understand possible reasons behind purchase decisions taken by their customers.

Optionally, the server 104 may be operable to analyze the customer information to correlate increase in sales with one or more marketing campaigns being provided at the retail stores. For this purpose, the server 104 may also be operable to analyze aggregate sales and marketing data.

More optionally, the server 104 may be operable to use the customer information in various marketing promotions. Such marketing promotions may be provided on third-party services, for example, including social networking services.

Moreover, the server 104 may be operable to collect statistical information pertaining to each of the customer service apparatus 102, and analyze the statistical information to determine one or more retail stores and/or one or more sections of a particular retail store that attract most customers.

It should be noted here that the implementation of the network environment 100 is not limited to a specific type or number of customer service apparatus, servers, databases and data communication networks. FIG. 1 is merely an example, which should not unduly limit the scope of the claims herein. One of ordinary skill in the art would recognize many variations, alternatives, and modifications of embodiments herein.

FIG. 2 is a schematic illustration of a customer service apparatus 200 for providing a service to a customer when assessing and/or purchasing one or more items, in accordance with an embodiment of the present disclosure. The customer service apparatus 200 includes an image capture arrangement 202, a data processing arrangement 204, an image presentation arrangement 206, and a communication arrangement 208. Optionally, the customer service apparatus 200 may also include a sensing arrangement 210.

The image capture arrangement 202 is operable to capture one or more images of the customer, and generate corresponding image data. The data processing arrangement 204 is then operable to receive the image data from the image capture arrangement 202, and process the image data to generate corresponding output data. Subsequently, the image presentation arrangement 206 is operable to receive the output data from the data processing arrangement 204, and present to the customer the images captured by the image capture arrangement 202.

Additionally, the image capture arrangement 202 may be operable to capture one or more three-dimensional images of the customer, wherefrom the image presentation arrangement 206 may be operable to present at least one of the three-dimensional images to the customer. For example, the image presentation arrangement 206 may be operable to spin a view of a three-dimensional image to present a 360 degree view to the customer.

It may be noted here that the image capture arrangement 202 may also be operable to capture one or more videos of the customer, wherefrom the image presentation arrangement 206 may be operable to present these videos to the customer. The term ‘image’ may refer to images as well as videos, throughout this specification and claims.

The data processing arrangement 204 may be implemented using a data processing device that includes computing hardware, which is operable to execute one or more software products recorded on non-transitory machine-readable data storage media. Accordingly, the data processing arrangement 204 may be operatively coupled with other components of the customer service apparatus 200, as shown in FIG. 2.

Additionally, the image capture arrangement 202 may include one or more digital cameras for capturing the images of the customer, while the image presentation arrangement 206 may include one or more pixel displays for presenting the images to the customer.

Beneficially, the pixel displays may be implemented as one or more touch screens that may be operable to receive touch commands from the customer. The touch commands received from the customer may then be communicated to the data processing arrangement 204 for controlling operation of the customer service apparatus 200.

Alternatively, the pixel displays may be implemented as one or more projection screens. In such a case, the customer service apparatus 200 may include an input receiving arrangement, for example, including one or more buttons for receiving inputs from the customer for controlling operation of the customer service apparatus 200.

Additionally or alternatively, the data processing arrangement 204 may be operable to identify one or more customer gestures in the images captured by the image capture arrangement 202, and use the customer gestures for controlling operation of the customer service apparatus 200.

In this manner, the data processing arrangement 204 may be operable to receive one or more inputs from the customer for various purposes. Such inputs may be received by way of at least one of: touch commands on the touch screens of the image presentation arrangement 206, customer gestures in the images captured by the image capture arrangement 202, and/or pressing of appropriate buttons of the input receiving arrangement.

In a first example scenario, the data processing arrangement 204 may be operable to receive the customer's feedback on one or more items worn or carried by the customer when the images of the customer were captured. The items may, for example, include clothing items and/or accessory items, such as apparels, spectacles, handbags, rucksacks, footwear and jewelry, and sports items, such as sport bicycles, racquets, golf clubs, balls and other sports equipment.

In a second example scenario, the data processing arrangement 204 may be operable to receive inputs from the customer for sharing the images of the customer with one or more parties. The parties may, for example, include one or more friends, family and/or peers of the customer.

Additionally, the parties may also include a plurality of subscribers or social media followers of a retail store in which the customer service apparatus 200 has been installed. Optionally, the images may also be shared on a website of the retail store.

In a third example scenario, the data processing arrangement 204 may be operable to receive inputs from the customer for requesting feedback from the parties. Based on these inputs, the communication arrangement 208 may be operable to communicate information derived from the images of the customer together with customer identification metadata to these parties.

Accordingly, the customer service apparatus 200 may include a customer identification arrangement that may be operable to identify the customer to generate the customer identification metadata. For example, the customer may be identified by at least one of: an online service credential of the customer on a social networking service, a unique identification code (ID) of the customer, a facial recognition technique, and/or other biometric recognition techniques known in the art. The online service credential and/or the unique ID of the customer may, for example, be provided by the customer him/herself.

Additionally, the information derived from the images may, for example, pertain to the items worn or carried by the customer when the images of the customer were captured. For example, information pertaining to a particular item may include at least one of: a type of that particular item, a name of a brand of that particular item, a name of a model of that particular item, a nature of that particular item, a size of that particular item, a price of that particular item, and/or a customer's feedback on that particular item.

Accordingly, the data processing arrangement 204 may be operable to identify the items worn or carried by the customer when the images of the customer were captured. For this purpose, the data processing arrangement 204 may be operable to perform one or more analyses on the images of the customer captured by the image capture arrangement 202. For example, the items may be identified by a suitable image recognition technique known in the art.

Additionally, the sensing arrangement 210 may be operable to sense one or more identification tags of the items worn or carried by the customer for determining their identity. An identification tag of a particular item may, for example, include a barcode related to that particular item. Additionally or alternatively, the identification tag may be a Radio-Frequency Identification (RFID) tag attached to the particular item. The RFID tag may be operable to emit a wireless signal carrying one or more codes indicative of a nature, type, size and/or form of that particular item. When the particular item is purchased, the RFID tag is removed from that particular item, reprogrammed and then reused for tagging other items at the retail store.

Additionally or alternatively, the customer service apparatus 200 may include a scanner for scanning the identification tags of the items for determining their identity.

Optionally, the data processing arrangement 204 may also be operable to provide additional information pertaining to the customer and/or the items. The additional information pertaining to a particular item may, for example, include a logo of a brand of that particular item and/or a text for that particular item. Accordingly, the data processing arrangement 204 may access the additional information pertaining to the items based on their identity, for example, via the server 104. Such information may, for example, have been stored in the database 108.

Additionally or alternatively, the additional information may be provided by the customer him/herself. This may allow the customer to customize the images according to his/her choice, for example, by tagging the items on which he/she wants feedback in these images.

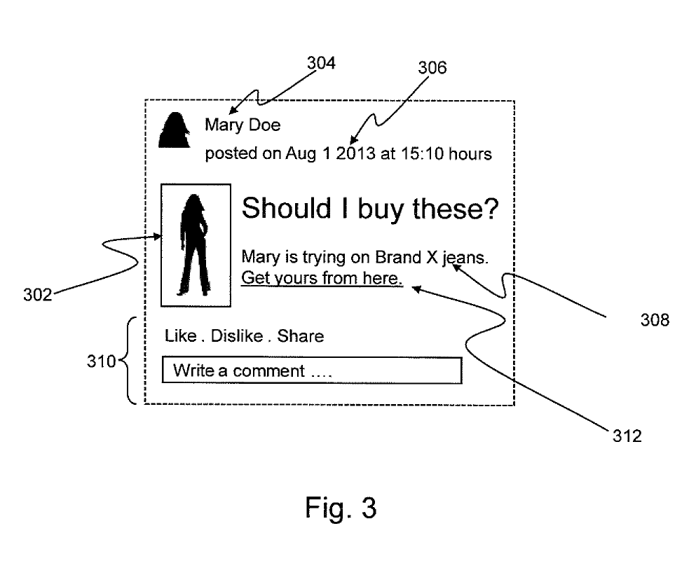

Upon identification of the items, the information derived from the images together with the customer identification metadata may be communicated to the parties using a social networking service, such as Facebook (“Facebook” is a registered trademark). An example image as shared with the parties for feedback has been provided in FIG. 3.

Additionally or alternatively, the information derived from the images together with the customer identification metadata may be communicated to the parties using a messaging service, such as Short Messaging Service (SMS), Multimedia Messaging Service (MMS), Enhanced Messaging Service (EMS), eXtended Messaging Service (XMS), and electronic mails (emails). The messaging service may be provided by the communication arrangement 208. Alternatively, the messaging service may be provided via the server 104.

Upon receipt, the parties may assess the information derived from the images in association with the customer identification metadata to provide feedback to be communicated to the customer. The feedback may, for example, be in a form of a star rating, a number-based rating, and/or word-based rating, such as “good” or “bad”, and “like” or “dislike”.

The communication arrangement 208 may then be operable to receive the feedback from the parties. Subsequently, the data processing arrangement 204 may be operable to supply to the customer the feedback received from the parties.

The feedback may be supplied to the customer either on a real-time basis or on a periodic basis.

In one example, the feedback may be supplied to the customer via the image presentation arrangement 206. This may be a case when the feedback may be supplied to the customer in real time.

In another example, the feedback may be supplied to a portable device of the customer. Examples of the portable device include, but are not limited to, a mobile phone, a smart phone, a Mobile Internet Device (MID), a tablet computer, an Ultra-Mobile Personal Computer (UMPC), a phablet computer, a Personal Digital Assistant (PDA), a web pad, a handheld Personal Computer (PC), and a laptop computer.

Accordingly, the portable device of the customer may be communicably coupled to the customer service apparatus 200, for example, using Wi-Fi or Bluetooth (“Bluetooth” is a registered trademark).

Alternatively, the image presentation arrangement 206 may present a unique code, such as a text and/or a Quick Response (QR) code, which may be scanned by a camera of the portable device to associate the customer service apparatus 200 with an application running on the portable device.

In yet another example, the customer may use his/her portable device to access the social networking service on which the parties were requested for their feedback. Accordingly, the customer may receive the feedback provided by the parties on the social networking service itself.

In still another example, the customer may use his/her portable device to receive the feedback via the messaging service.

Beneficially, the feedback may be supplied in a form of a peer-review of the customer's choice of the items. Such feedback may help the customer to take a decision on whether or not to purchase one or more of the items worn or carried by the customer when the images of the customer were captured. In this manner, the customer service apparatus 200 allows the customer to receive feedback from his/her friends, family and/or peers, who may not be physically present with the customer. This may facilitate a virtual social experience for the customer.

In a fourth example scenario, the data processing arrangement 204 may be operable to receive inputs from the customer for purchasing one or more of the items.

Moreover, the customer service apparatus 200 may be operable to select one or more recommended and/or related items, based upon the items worn or carried by the customer when the images of the customer were captured. The customer service apparatus 200 may then be operable to present these recommended and/or related items to the customer via the image presentation arrangement 206.

Beneficially, the recommended and/or related items may be presented to the customer in a manner overlaid onto a presented image of the customer as captured by the image capture arrangement 202. This may facilitate a personalized shopping experience for the customer.

Accordingly, the data processing arrangement 204 may be operable to receive inputs from the customer for purchasing one or more of the recommended and/or related items presented to the customer by the customer service apparatus 200.

In this manner, the data processing arrangement 204 may be operable to receive inputs from the customer for various purposes, such as sharing images, requesting feedback and purchasing items, as described above.

Furthermore, the data processing arrangement 204 may be operable to present targeted advertisement to the customer via the image presentation arrangement 206. The targeted advertisement may be based, at least in part, upon the customer identification metadata, and/or the identification of the items worn or carried by the customer when the images of the customer were captured.

In this manner, the customer service apparatus 200 allows the store owner and/or advertisers to provide targeted advertising to the customer.

Optionally, the customer service apparatus 200 may allow the customer to participate in various marketing campaigns being provided at the retail store.

Moreover, the data processing arrangement 204 may be operable to provide one or more portrait images of the customer as captured by the image capture arrangement 202. Accordingly, the data processing arrangement 204 may also be operable to receive inputs from the customer for sharing the portrait images of the customer with the parties.

Moreover, the customer service apparatus 200 may be operable to provide the customer substantially simultaneously with a plurality of views of the customer in real time. This may help the customer to browse through the plurality of views and/or the images to compare the items that he/she has worn or carried, and consider purchasing one or more of the items.

Beneficially, the customer service apparatus 200 may be configurable to function as a mirror for providing the customer with a real-time image of the customer at one or more viewing angles. Accordingly, the pixel displays may be large in size, so as to be operable to present a full view of the images of the customer.

Furthermore, embodiments of the present disclosure are suitable for retailing environments, such as retail stores, exhibitions, outdoor marketing events and amusement parks, but not limited thereto. The customer service apparatus 200 may be implemented as the customer service apparatus 102. For illustration purposes, let us consider that the customer service apparatus 200 may be spatially implemented for use in a retail store.

As described earlier, the customer service apparatus 200 may enable a store owner of the retail store to understand trends and patterns in behavior of customers. For this purpose, the data processing arrangement 204 may be operable to store customer information in the database 108.

For example, customer information pertaining to a particular customer may include information pertaining to at least one of: customer identification metadata corresponding of that particular customer, a gender of that particular customer, an age group to which that particular customer belongs, one or more items identified in one or more images of that particular customer, time and date when these images were captured, a sequence in which the items were tried by that particular customer, one or more of the items for which feedback was requested, one or more parties from which the feedback was requested, the feedback received from the parties, and/or whether or not the customer purchased the items from the retail store.

Therefore, the customer information pertaining to the particular customer provides information about at least one of:

(a) one or more items that are of interest to the particular customer,
(b) interest flow from one item to other,
(c) one or more items that are of interest to the particular customer but are not purchased by the particular customer, and/or
(d) one or more items that are purchased by the particular customer.

As described earlier, the customer information may be accessed by the server 104 for use in at least one of: marketing and sales analyses, marketing campaigns, marketing promotions, and/or aggregate sales and marketing data.

FIG. 2 is merely an example, which should not unduly limit the scope of the claims herein. It is to be understood that the specific designation for the customer service apparatus 200 is for the convenience of reader and is not to be construed as limiting the customer service apparatus 200 to specific numbers, types, or arrangements of modules and/or components of the customer service apparatus 200. One of ordinary skill in the art would recognize many variations, alternatives, and modifications of embodiments of the present disclosure. For example, the customer service apparatus 200 may be implemented in a similar manner for capturing one or more videos of the customer, presenting the videos to the customer, and sharing the videos with the parties for their feedback.

FIG. 3 is an illustration of an example image 302 of the customer as shared by the customer service apparatus 200 with the parties for feedback, in accordance with an embodiment of the present disclosure.

With reference to FIG. 3, the example image 302 is provided along with a name 304 of the customer, a date and time 306 when the example image 302 was shared, and a name 308 of a brand of an item worn by the customer in the example image 302.

In addition, the example image 302 is provided with one or more feedback options 310 for the parties to provide the feedback on the item worn by the customer in the example image 302. For example, the parties may “like” or “dislike” the item, and/or write a comment on the example image 302.

Moreover, the example image 302 is also provided with an advertisement 312 targeted to the parties. Such advertisements may allow the retail stores and/or brands to reach potential customers through their existing customers.

Moreover, the brands may pay the retail stores for such advertisements, based on a number of times the parties clicked on such advertisements, and/or a number of purchases initiated through such advertisements.

FIG. 3 is merely an example, which should not unduly limit the scope of the claims herein. One of ordinary skill in the art would recognize many variations, alternatives, and modifications of embodiments of the present disclosure.

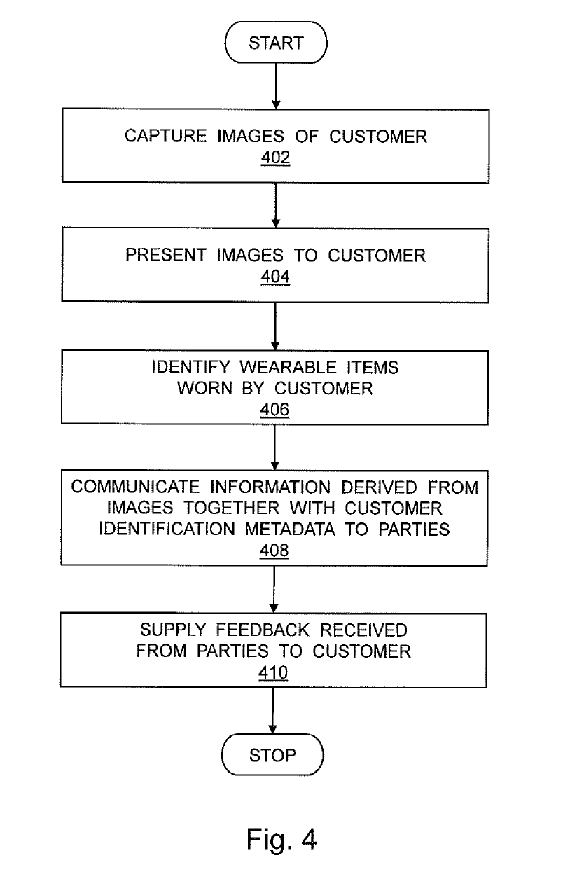

FIG. 4 is an illustration of steps of a method of operating the customer service apparatus 200, in accordance with an embodiment of the present disclosure. The method is depicted as a collection of steps in a logical flow diagram, which represents a sequence of steps that can be implemented in hardware, software, or a combination thereof.

At a step 402, the image capture arrangement 202 operates to capture one or more images of a customer. In accordance with the step 402, the image capture arrangement 202 may operate to generate image data corresponding to the images. Subsequently, the data processing arrangement 204 may operate to process the image data to generate corresponding output data.

Next, at a step 404, the image presentation arrangement 206 operates to present to the customer the images captures at the step 402. In accordance with the step 404, the image presentation arrangement 206 may operate to receive the output data from the data processing arrangement 204.

It may be noted here that the image capture arrangement 202 may operate to capture one or more videos of the customer at the step 402, wherefrom the image presentation arrangement 206 may operate to present these videos to the customer at the step 404. As mentioned earlier, the term ‘image’ may refer to images as well as videos, throughout this specification and claims.

Next, at a step 406, the data processing arrangement 204 operates to identify one or more items worn or carried by the customer in the images captured at the step 402.

As described earlier, the data processing arrangement 204 may operate to receive inputs from the customer for sharing the images and/or requesting feedback on the items.

Subsequently, at a step 408, the communication arrangement 208 operates to communicate information derived from the images together with the customer identification metadata to one or more parties. The communication arrangement 208 may also operate to receive the feedback from the parties.

Thereafter, at a step 410, the data processing arrangement 204 operates to supply to the customer the feedback received from the parties. The step 410 may be performed either on a real-time basis or on a periodic basis, as described earlier.

The feedback may help the customer to take a decision on whether or not to purchase one or more of the items. In this manner, the method allows the customer to receive feedback from his/her friends, family and/or peers, who may not be physically present with the customer. This may facilitate a virtual social experience for the customer.

Furthermore, the method may include an additional step at which the data processing arrangement 204 may operate to receive inputs from the customer for purchasing one or more of the items.

Additionally, the method may include one or more additional steps at which the data processing arrangement 204 may operate to select one or more recommended and/or related items, based upon the items identified at the step 406, wherefrom the image presentation arrangement 206 may operate to present the recommended and/or related items to the customer.

It should be noted here that the steps 402 to 410 are only illustrative and other alternatives can also be provided where one or more steps are added, one or more steps are removed, or one or more steps are provided in a different sequence without departing from the scope of the claims herein.

Embodiments of the present disclosure can be used for various purposes, including, though not limited to, enabling customers to take decisions on whether or not to purchase particular items, by allowing the customers to receive feedback from their friends, family and/or peers, who may not be physically present with them, and thereby facilitating virtual social experiences for the customers; facilitating personalized shopping experiences for the customers; enabling store owners of retail stores to understand trends and patterns in behavior of their customers; and allowing the store owners and/or advertisers to provide targeted advertising to the customers.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A customer service apparatus for providing a service to a customer when assessing and/or purchasing one or more items, wherein the customer service apparatus includes an image capture arrangement for capturing one or more images of the customer and generating corresponding image data, a data processing arrangement for processing the image data for generating corresponding output data, and an image presentation arrangement for receiving the output data from the data processing arrangement for presenting to the customer the one or more images captured by the image capture arrangement,
wherein the data processing arrangement is operable to identify one or more items worn or carried by the customer when the one or more images of the customer were captured, and
wherein the customer service apparatus further includes a communication arrangement for communicating information derived from the one or more images of the customer together with customer identification metadata to one or more parties for assessing the information derived from the one or more images in association with the customer identification metadata, and for receiving feedback from the one or more parties to be communicated to the customer.

2. The customer service apparatus as claimed in claim 1, wherein the image capture arrangement includes one or more digital cameras for capturing the one or more images of the customer, and the image presentation arrangement includes one or more pixel displays for presenting the one or more images to the customer.

3. The customer service apparatus as claimed in claim 2, wherein the one or more pixel displays are implemented as one or more touch screens, wherein the one or more touch screens are operable to receive touch commands from the customer that are communicated to the data processing arrangement for controlling operation of the customer service apparatus.

4. The customer service apparatus as claimed in claim 2, wherein the one or more pixel displays are implemented as one or more projection screens.

5. The customer service apparatus as claimed in claim 1, wherein the data processing arrangement is operable to identify one or more customer gestures in the one or more images captured by the image capture arrangement, and to use the one or more customer gestures for controlling operation of the customer service apparatus.

6. The customer service apparatus as claimed in claim 1, wherein the data processing arrangement is operable to perform one or more analyses on the one or more images for identifying the one or more items worn or carried by the customer when the one or more images of the customer were captured.

7. The customer service apparatus as claimed in claim 1, wherein the customer service apparatus includes a sensing arrangement for sensing one or more identification tags of the one or more items worn or carried by the customer for determining their identity.

8. The customer service apparatus as claimed in claim 1, wherein the customer service apparatus is operable to present to the customer, via the image presentation arrangement, one or more recommended and/or related items based upon the one or more items worn or carried by the customer when the one or more images of the customer were captured.

9. The customer service apparatus as claimed in claim 8, wherein the one or more recommended and/or related items are presented to the customer in a manner overlaid onto a presented image of the customer as captured by the image capture arrangement.

10. The customer service apparatus as claimed in claim 1, wherein the image capture arrangement is operable to capture one or more three-dimensional images of the customer, wherefrom the image presentation arrangement is operable to present at least one of the one or more three-dimensional images to the customer.

11. The customer service apparatus as claimed in claim 1, wherein the data processing arrangement is operable to supply to the customer the feedback received from the one or more parties in a form of a peer-review of the customer's choice.

12. The customer service apparatus as claimed in claim 1, wherein the data processing arrangement is operable to present targeted advertisement to the customer via the image presentation arrangement, wherein the targeted advertisement is based, at least in part, upon the customer identification metadata, and/or identification of the one or more items worn or carried by the customer when the one or more images of the customer were captured.

13. The customer service apparatus as claimed in claim 1, wherein the data processing arrangement is operable to receive input from the customer for purchasing one or more items presented by the customer service apparatus via its image presentation arrangement to the customer.

14. The customer service apparatus as claimed in claim 1, wherein the data processing arrangement is operable to store information pertaining to the customer for use in at least one of: marketing and sales analyses, marketing campaigns, marketing promotions, and/or aggregate sales and marketing data.

15. The customer service apparatus as claimed in claim 1, wherein the data processing arrangement is operable to provide one or more portrait images of the customer as captured by the image capture arrangement.

16. The customer service apparatus as claimed in claim 1, wherein the customer service apparatus is configurable to function as a mirror for providing the customer with a real-time image of the customer at one or more viewing angles.

17. The customer service apparatus as claimed in claim 16, wherein the customer service apparatus is operable to provide the customer substantially simultaneously with a plurality of views of the customer in real time.

18. A method of operating a customer service apparatus for providing a service to a customer when assessing and/or purchasing one or more items, wherein the customer service apparatus includes an image capture arrangement for capturing one or more images of the customer and generating corresponding image data, a data processing arrangement for processing the image data for generating corresponding output data, and an image presentation arrangement for receiving the output data from the data processing arrangement for presenting to the customer the one or more images captured by the image capture arrangement,
wherein the method includes:
(a) operating the data processing arrangement to identify one or more items worn or carried by the customer when the one or more images of the customer were captured; and
(b) operating a communication arrangement of the customer service apparatus for communicating information derived from the one or more images of the customer together with customer identification metadata to one or more parties for assessing the information derived from the one or more images in association with the customer identification metadata, and for receiving feedback from the one or more parties to be communicated to the customer.

19. The method as claimed in claim 18, wherein the method includes providing the image capture arrangement with one or more digital cameras, and providing the image presentation with one or more pixel displays.

20. The method as claimed in claim 19, wherein the method includes implementing the one or more pixel displays as one or more touch screens, wherein the one or more touch screens are operable to receive touch commands from the customer that are communicated to the data processing arrangement for controlling operation of the customer service apparatus.

21. The method as claimed in claim 19, wherein the method includes implementing the one or more pixel displays as one or more projection screens.

22. The method as claimed in claim 18, wherein the method includes operating the data processing arrangement to identify one or more customer gestures in the one or more images captured by the image capture arrangement, and to use the one or more customer gestures for controlling operation of the customer service apparatus.

23. The method as claimed in claim 18, wherein the method includes operating the data processing arrangement to perform one or more analyses on the one or more images for identifying the one or more items worn or carried by the customer when the one or more images of the customer were captured.

24. The method as claimed in claim 18, wherein the method includes providing the customer service apparatus with a sensing arrangement for sensing one or more identification tags of the one or more items worn or carried by the customer for determining their identity.

25. The method as claimed in claim 18, wherein the method includes operating the customer service apparatus to present to the customer, via the image presentation arrangement, one or more recommended and/or related items based upon the one or more items worn or carried by the customer when the one or more images of the customer were captured.

26. The method as claimed in claim 25, wherein the method includes presenting the one or more recommended and/or related items to the customer in a manner overlaid onto a presented image of the customer as captured by the image capture arrangement.

27. The method as claimed in claim 18, wherein the method includes operating the image capture arrangement to capture one or more three-dimensional images of the customer; and
operating the image presentation arrangement to present at least one of the one or more three-dimensional images to the customer.

28. The method as claimed in claim 18, wherein the method includes operating the data processing arrangement to supply to the customer the feedback received from the one or more parties in a form of a peer-review of the customer's choice.

29. The method as claimed in claim 18, wherein the method includes operating the data processing arrangement to present targeted advertisement to the customer via the image presentation arrangement, wherein the targeted advertisement is based, at least in part, upon the customer identification metadata, and/or identification of the one or more items worn or carried by the customer when the one or more images of the customer were captured.

30. The method as claimed in claim 18, wherein the method includes operating the data processing arrangement to receive input from the customer for purchasing one or more items presented by the customer service apparatus via its image presentation arrangement to the customer.

31. The method as claimed in claim 18, wherein the method includes operating the data processing arrangement to store information pertaining to the customer for use in at least one of: marketing and sales analyses, marketing campaigns, marketing promotions, and/or aggregate sales and marketing data.

32. The method as claimed in claim 18, wherein the method includes operating the data processing arrangement to provide one or more portrait images of the customer as captured by the image capture arrangement.

33. The method as claimed in claim 18, wherein the method includes configuring the customer service apparatus to function as a mirror for providing the customer with a real-time image of the customer at one or more viewing angles.

34. The method as claimed in claim 33, wherein the method includes operating the customer service apparatus to provide the customer substantially simultaneously with a plurality of views of the customer in real time.

35. A software product recorded on non-transitory machine-readable data storage media, wherein the software product is executable upon computing hardware for implementing the method as claimed in claim 18.
